(19) United States
(12) Patent Application Publication
(10) Pub. No.: US 2021/0213674 A1
(43) Pub. Date: Jul. 15, 2021

(54) METHOD TO FORM A FIRST AND A SECOND THREE-DIMENSIONAL OBJECTS FROM A FIRST AND A SECOND SOLIDIFIABLE MATERIALS BEING CAPABLE OF SOLIDIFYING UPON IMPINGEMENT THEREON OF ELECTROMAGNETIC RADIATION

(71) Applicant: DWS s.r.l., Thiene (VI) (IT)

(72) Inventor: Ettore Maurizio COSTABEBER, Rome (IT)

(73) Assignee: DWS S.r.l., Thiene (VI) (IT)

(21) Appl. No.: 17/056,250

(22) PCT Filed: May 17, 2019
(86) PCT No.: PCT/EP2019/062885

§ 371 Date: Nov. 17, 2020

(30) Foreign Application Priority Data
May 17, 2018 (IT) 10 2018 00005478

(51) Int. Cl. B29C 64/124; B29C 64/171; B29C 64/245; B29C 64/268; B29C 64/336; B29C 64/386; B29C 35/08; B33Y 10/00; B33Y 30/00; B33Y 40/20; B33Y 70/00; B33Y 80/00

(52) U.S. Cl. CPC B29C 64/124; B29C 64/171; B29C 64/245; B29C 64/268; B29C 64/336; B29C 64/386; B29L 2031/7532; B33Y 10/00; B33Y 30/00; B33Y 40/20; B33Y 70/00; B33Y 80/00; B29C 35/0805

(57) ABSTRACT

The present invention relates to a method to form a three-dimensional object including a first and a second component (01, 02) from a first and a second solidifiable materials (5a, 5b) being capable of solidifying upon impingement thereon of electromagnetic radiation, the method comprising: o providing a main digital image of the three dimensional object; o introducing said first and said second solidifiable material (5a, 5b) in a first and a second chamber (2a, 2b), respectively; o elaborating the main digital image dividing it in a first digital image corresponding to the first component and a second digital image corresponding to the second component; o associating the first component to the first chamber and the second component to the second chamber; o irradiating by means of an electromagnetic source (6) a layer of said first and/or said second solidifiable material (5a, 5b), according to a given pattern, in order to selectively solidify the layer of the first and/or the second solidifiable material; o repeating the process for a plurality of layers to form the first and the second components (01, 02) of the three dimensional object; o while repeating the process, forming the first and the second components in parallel, by irradiating both chambers at the same time, or by alternating the irradiation from the first to the second chamber and vice versa.

“Stereolithography” is a method and apparatus for making solid three-dimensional objects by successively “printing” thin layers of a solidifiable (e.g. curable) material, one on top of the other. A programmed movable spot beam of radiation shining on a surface or layer of a curable liquid material is used to form a solid cross-section of the object at the surface of the material. The object is then moved, in a programmed manner, away from the liquid surface by the thickness of one layer, and the next cross-section is then formed and adhered to the immediately preceding layer defining the object. This process is continued until the entire object is formed.

Essentially all types of object forms can be created with this technique. Complex forms are more easily created by using the functions of a computer to help generate the programmed commands and to then send the program signals to the stereolithographic object forming subsystem.

A stereolithography machine of the known type comprises a container in which there is the fluid substance, generally a light-sensitive resin in the liquid or pasty state.

The machine comprises also a source that is generally of the luminous type and emits radiation suited to solidify the fluid substance. An optical unit provides for conveying said radiation towards a reference surface arranged inside the container, which corresponds to the position of the layer of the object to be solidified.

The three-dimensional object being formed is supported by a modelling plate, which can be moved vertically with respect to the container, in such a way as to allow the last solidified layer of the object to be arranged in a position adjacent to said reference surface.

In this way, once each layer has been solidified, the modelling plate is moved in such a way as to arrange the solidified layer so that it is again adjacent to the reference surface, after which the process can be repeated for the successive layer.

The use of these machines has become more and more popular in different technical fields due to the accuracy reached and the vast variety of shapes that can be obtained. However, a problem may arise when an object needs to be produced which is composed of different materials.

Indeed, in a single stereolithographic process, generally a single resin is used. The resin is then solidified to produce the item. Therefore, if an object has different components in different material, a single stereolithographic process needs to be performed for each of the components so that each of the components can be formed using a different resin.

However, in some technical field, for example in the medical field, care has to be taken when multi-parts objects are produced. Indeed, there are even regulations which impose that there should always be a clear traceability of the components forming a single object and a clear identification of the person (patient) to whom they are associated. For example, each manufacturer has to establish and maintain procedures for identifying product during all stages of receipt, production, distribution, and installation to prevent mix-ups. Therefore, when an item is formed in more than one component, it is very important that the components printed remain associated one to the other and, moreover, remain associated to a given identifier, which could be for example a patient name.

This is of particular importance for example in the dental field, where a portion of the gum and a tooth are often reproduced by stereolithography in two different materials, however the parts of the reproductions need to remain linked together and to the patient name, preferably at each stage from the dentist office where the scan is made till the finished product.

There is therefore a need for a method which allow a better control of traceability of three dimensional models of items which are produced in more parts.

According to a first aspect, the invention relates to a method to form a three-dimensional object including a first and a second component from a first and a second solidifiable materials being capable of solidifying upon impingement thereon of electromagnetic radiation, the method comprising:
providing a main digital image of the three dimensional object;
introducing said first and said second solidifiable material in a first and a second chamber, respectively;
elaborating the main digital image dividing it in a first digital image corresponding to the first component and a second digital image corresponding to the second component;
associating the first component to the first chamber and the second component to the second chamber;
irradiating by means of an electromagnetic source a layer of said first and/or said second solidifiable material, according to a given pattern, in order to selectively solidify the layer of the first and/or the second solidifiable material;
repeating the process for a plurality of layers to form the first and the second components of the three-dimensional object;
while repeating the process, forming the first and the second components in parallel, by irradiating both chambers at the same time, or by alternating the irradiation from the first to the second chamber and vice versa.

The method of the invention therefore uses a stereolithographic process to form a single three-dimensional (3D) object comprising at least a first and a second three dimensional components which are made of a first and a second material, where the first material is different from the second material.

A three dimensional object, also called in the following “item”, may be formed of N components, where N≥2. With the word “item” a real physical object may be intended, or a digital 3D model of the same. Possibly, the components forming the item may be made of different materials or compositions. In order to obtain a stereolithographic copy of the item and thus of the N components in the same stereolithographic process, a digital image of the item, called main digital image, is needed.

The main digital image is then divided in digital separated images of the various N components. Each component is then assigned to a different chamber of the same stereolithographic machine to keep the relationship “one item” (regardless of the number of components in which is composed) equal “one process”. In this way, to a single initial item, for example a part of the human body and thus to a single patient, all the components forming the same are produced in a single process step, so that traceability is improved.

The stereolithographic machine used in the method of the invention includes at least 2 chambers, preferably N chambers, where N≥2 is the number of components in which the item is formed. Further, the stereolithographic machine uses a number of solidifiable materials preferably equal to the number of chambers (that is, there are N different solidifiable materials), so that into each chamber preferably a different material can be introduced. Preferably, the solidifiable material is in fluid form (i.e., it is a liquid).

Preferably, the N solidifiable materials differ one from the other for at least a physical and/or chemical characteristic. If N>2, at least two of the N materials are preferably different from each other for a physical and/or chemical characteristic.

The solidifiable materials are materials which solidify when irradiated by an electromagnetic radiation having specific characteristics, for example a specific wavelength. They can be for example polymeric resins. Any of the polymeric resins known in the art of stereolithographic processing can be used in the present invention.

Further, the stereolithographic machine used in the method of the invention includes an electromagnetic source, apt to emit an electromagnetic radiation. Preferably, the electromagnetic source is tunable, that is, the parameters of the emitted electromagnetic radiation can be varied. For example, the power of the electromagnetic radiation can be changed, the time of emission, the wavelength, the speed in which the radiation is scanned, the laser spot size, etc. Preferred electromagnetic source are a laser source, more preferably a UV laser source emitting a laser beam in the UV spectrum, and a digital light projector, more preferably a digital light projector emitting in the UV spectrum.

A processor is further present to elaborate the digital image(s) of the item and to command the electromagnetic source, as detailed below. The processor maybe integral with the stereolithographic machine or separated from the same.

Preferably, the processor is associated with a user interface which can be used by an operator of the stereolithographic machine to input and/or select and/or change parameters of the stereolithographic process.

The main digital image of the item may be contained in a single file in which the whole item is depicted, or in a plurality of different files, for example one per component. The main digital image is considered in the following as a three-dimensional digital image. The main digital image contains the mathematical representation of the surface of the item in three dimensions, for example via specialized software such as CAD.

The information contained in the main digital image of the item are preferably the following. The main digital image preferably contains the necessary information to form a 3D representation of the item. The main digital image may be a file obtained by a 3D scanner: it is a “digital impression” of the item of interest. For example a Mesh representation can be used. Alternatively, other mathematical geometries can be used as well, such as Splines, NURBS, known in the field.

The main digital image obtained can be produced directly during the method of the invention, for example, by a 3D scanner, so that a scan of the item is performed and the scanner itself outputs a digital image of the item. Alternatively or in addition, there is no “real physical item” of which a digital image is taken, the item is present in a digital form only, for example as a design or as a project (e.g. a CAD model). This is the case for example when a prosthesis needs to be formed, such as a pair of glasses or a hearing aid.

In addition to the position information of the surface of the item in a three-dimensional space, at each point whose coordinates are determined, the main digital image may contain also additional information, for example about the colour of the components of the item in different points.

Therefore, a main digital image may be generated associating to each Mesh vertex the value of other characteristics of the item, for example its colour in RGB coordinates or in another manner.

This main digital image is then separated in a first and a second digital image, one per component. This step is performed unless the main digital image is already supplied divided in components. The first and second digital images may be saved in a single file, or in more than one file.

The first and second digital images are considered in the following as three-dimensional digital images. The first and second digital images contain the mathematical representation of the surface of the first and second components, respectively, in three dimensions, for example via specialized software such as CAD.

Further, the step of elaborating the file dividing the main digital image in a first digital image and in a second digital may include a transformation of the file containing the main digital image in a file readable by the stereolithographic machine. Further the term “file” is used in a broad meaning, with file intending all the information relating to a given aspect, for example a file of a digital image means all the information needed to form a digital image, regardless whether these info are in a single “physical file” image.dat or in a plurality of files image1.dat image2.dat. File is thus a collection of data stored in a file unit, identified by a file name. As long as the file relating to the image of the first component and the file relating to the image of the second component are clearly identifiable, i.e. the collection of data are complete and separated, the filenames of the two can be the same.

The elaboration of the main digital image to divide it in the first and second digital image of the first and second components may take place as follows.

The different components forming the item and visible in the main digital image may be selected by an operator, so that the various components can be separated “manually”, in the meaning that the operator indicates to a suitable software which parts of the main digital image need to be separated in different parts forming thus the first and second different images.

Alternatively or in addition, the components forming the item can be separated automatically. When it comes to the automatic separation, the operator may input the rule(s) for the separation, for example may indicate that the various components are those parts of the item (as saved in the main digital image) which differ in colours. Alternatively or in addition, a set of rules may be already present inside the processor and selected during manufacturing of the stereolithographic machine, so that all main digital images are processed according to these stored rules without waiting for any input from the operator.

After the N components of the item as represented in its main digital image have been separated forming different N digital images, the method of the invention includes the step of associating each component to a chamber of the plurality of N chambers of the stereolithographic machine. In turn, this step associates each digital image to a chamber, such as it associates the first digital image to the first chamber and the second digital image to the second chamber. As indicated above, in each chamber a different solidifiable material can be introduced, so that the N components can be produced in N different materials. If N>2, it suffices that only 2 among the N materials are different from each other, that is, there might be two components which are associated to the same solidifiable material although produced in different chambers of the stereolithographic machine.

The association takes place selecting which component is produced in which chamber. The selection is performed considering the size of the components, the size of the chambers (which may have different sizes), and the available solidifiable materials. Each component may be associated to a specific volume in each chamber or automatically positioned in the chamber where a big enough volume is present. In the first case, an operator may select the exact location in the chamber where the components are going to be produced.

In each chamber, more than one component in the same material can be produced. For example, the item may be composed by N>2 components, two of which are made of the same material. The three-dimensional components made of the same material therefore can be produced in the same chamber, if the latter is big enough.

Preferably, via the interface of a suitable software, the operator selects the volumes in the chambers where the components are to be formed.

At the end of this step, the information regarding which component is to be produced in which chamber and in which material is present in the processor, together with the spatial information about each component.

The method of the invention applies preferably standard lithographic techniques to the production of the three-dimensional components, to simultaneously execute computer aided design (CAD) and computer aided manufacturing (CAM) in producing three-dimensional objects directly from computer instructions.

In the following, a standard lithographic technique is described, however any 3D printing technique layer-by-layer can be used in the method of the present invention.

The data base of a CAD system can take several forms. One form consists of representing the surface of an object as a mesh of polygons, typically triangles. These triangles completely form the inner and outer surfaces of the object. This CAD representation also includes a unit length normal vector for each triangle. The normal points away from the solid which the triangle is bounding and indicate slope. The method of the invention preferably processes CAD data, into layer-by-layer vector data that can be used for forming models through stereolithography. Such information may ultimately be converted to raster scan output data or the like in case of DLP or in a vector format.

First, preferably the solid model is designed in the normal way on the CAD system, without specific reference to the stereolithographic process. These are the digital images of the components of the item. In the following therefore a digital image of a component is called the model of the component.

Model preparation for stereolithography involves selecting the optimum orientation, adding supports, and selecting the operating parameters of the stereolithography system. The stereolithography operating parameters include selection of the model scale and layer (slice) thickness.

The surface of the solid model is then divided into triangles. A triangle is the least complex polygon for vector calculations. The more triangles formed, the better the surface resolution and hence, the more accurate the formed object with respect to the CAD design.

Data points representing the triangle coordinates and normals thereto are then transmitted typically as PHIGS, to the stereolithographic system via appropriate network communication such as ETHERNET or wireless connection. The software of the stereolithographic system then slices the triangular sections horizontally (X-Y plane) at the selected layer thickness.

The stereolithographic machine next calculates the section boundary, hatch, and horizontal surface (skin) vectors. Hatch vectors consist of cross-hatching between the boundary vectors. Several “styles” or slicing formats are available. Skin vectors, which are traced at high speed and with a large overlap, form the outside horizontal surfaces of the object.

In other words, the digital representation (model) of each component is divided in layers (process called slicing), each layer being a cross section of the component. The three-dimensional component is thus printed “layer by layer”.

The thickness of the layer may differ depending on the component. In this case, therefore, the number of layers necessary to form the first component in the first chamber may be different from the number of layers necessary to form the second component in the second chamber.

Given the above elaboration, where the slicing has been performed, the first and second chamber (or the N chambers) are irradiated accordingly. The stereolithoraphic machine and/or the processor therefore contains not only the digital images of the N components (the three dimensional model of the same) and the position in which they are formed in the chambers, but also the information on the slicing (the number of layers each component needs in order to be formed) and the parameters of the electromagnetic source to be set during irradiation.

The parameters of the electromagnetic source as well as those of the slicing can be modified at any time during the process.

The stereolithographic machine then forms the first and second components one layer at a time, preferably one horizontal layer at the time, preferably by moving the electromagnetic radiation across a surface of the first and the second solidifiable material and solidifying the same where it strikes, layer by layer. Each layer is comprised of vectors which are typically drawn in the following order: hatch and border. Alternatively, the whole area to be solidified is illuminated by electromagnetic radiation, layer by layer.

In order to form the layers, first of all the first and second solidifiable materials are introduced in the first and second chamber. The electromagnetic source then irradiates the first chamber according to the slice to be executed of the first digital image of the first component and irradiates the second chamber according to the slice to be executed of the second digital image of the second component.

The three-dimensional components, in the first and in the second chamber, are produced in parallel and not in series. This means that before the irradiation of one of the first and second components has finished, the irradiation of the other of the first or second component has started. For example, before a last layer of the first three dimensional component has been irradiated, at least a first layer of the second three dimensional component has been irradiated.

In order to perform a parallel processing of the components, different techniques can be used, depending on the type of electromagnetic source provided. In case of a laser as an electromagnetic source, for each layer of the first three-dimensional component or of the second three dimensional component, the laser scans either an area in the first chamber or an area in the second chamber according to the pattern provided in the first or second digital image.

The laser may first scan the whole area to be scanned of the first component in the first chamber and then the whole area to be scanned of the second component in the second chamber. Alternatively, the laser does not scan the whole area in each chamber, but simply continues along a given scanning direction continuously alternating from the first to the second chamber (for example scanning a line for a part in the first chamber and for a part in the second chamber).

Irradiating or solidifying according to a “pattern” means that the solidifiable material is irradiated or solidified only in a portion thereof corresponding to a given pattern. The pattern is determined in the slicing procedure, where the layers are defined, and substantially correspond to the cross section of the model (of the first digital image or of the second digital image) at the level of the layer considered.

Therefore, the laser scans either the first or the second material in the first or in the second chamber and it is therefore alternating between the first and the second chamber. Said alternation between the first and the second chamber occurs repeatedly throughout the process of printing the first three-dimensional component in parallel with the second three-dimensional component. There is therefore a recursively alternating irradiation from the first to the second chamber and vice versa.

In case of a digital projector, a given area in both the first and in the second chamber is illuminated. The areas exposed have a given pattern which is again given by the information contained in the first and second digital images of the components, preferably as elaborated during the slicing procedure. The exposure time may vary, that is, for each layer the first solidifiable material may need a different exposure time than the second solidifiable material. In the latter case, there is a first time interval when both first and second chambers are irradiated and a second time interval when only one of the first and second chamber is irradiated.

By means of this irradiation, a layer in which a part is solidified according to the pattern as indicated in the slicing procedure (as per the first digital image of the first component) is present in the first chamber, and a layer in which a part is solidified according to the pattern as indicated in the slicing procedure (as per the second digital image of the second component) is present in the second chamber.

This irradiation continues layer by layer till the first and the second components are completely formed: the first component may be formed by m layers while the second component may be formed by p layers, and therefore it means that all m and p layers have been irradiated according to their corresponding patterns indicated in the first and second digital image.

In order to irradiate all layers, each time a layer has been irradiated and thus solidified at least for a portion thereof, the solidified layer may be moved. Therefore, preferably, after the step of irradiating a layer, the method includes the step of moving the solidified layer of the first and the second solidifiable material. Alternatively, the irradiation source may be moved.

Any movement of the layer can be considered as known in the art. For example the following can be applied.

The stereolithographic machine may include a first and a second platform, associated to the first and second chambers. The platforms are used as “layer holders”. In the following the movement of a platform is described, the movement may apply to the first and/or second platform. The platform are preferably horizontal and their movement is a vertical movement along a Z axis. More preferably, the first and the second chambers define each a bottom and the movement of the platform is orthogonal to a plane defined by the bottom of the chambers.

Preferably, the layer that has been irradiated and solidified by the electromagnetic source adheres to the platform located just below the liquid surface. This platform is attached to an elevator which then lowers or raises the platform, for example under the processor's control. After irradiating a layer, the platform dips or raises for a short distance, such as several millimeters into the liquid solidifable material to coat the previous solidified layer with fresh solidifiable material, then rises up or lower a smaller distance leaving a thin film of liquid from which the second layer will be formed. After a pause to allow the liquid surface to flatten out, the next layer is irradiated. Since the solidifiable has adhesive properties, the second layer becomes firmly attached to the first. This process is repeated in both the first and the second chambers alternating the movement of the platforms or simultaneously, until all the layers have been irradiated and the entire first and second three-dimensional object is formed.

At the end of the process therefore, the first three-dimensional component is formed on the first platform and the second three-dimensional component is formed in the second platform.

All the standard modification or addition typical of a stereolithographic process can be applied to the method of the invention as well, for example in each layer an external boundary or pattern is defined within which the laser has to scan and polymerize the solidifiable material. However, in order to obtain better surface characteristics, not only the “interior” of the boundary is scanned, but a contouring of the same (i.e. the laser beam spot follows the contour of the boundary of the pattern for each layer) is also preferably performed. This contouring is possible for example by using vector scanning in a stereolithography machine.

The first and second three-dimensional components are thus formed inside the same machine and are ready at the same time at the end of the process. One of the two components may be finished first, however the process finishes only when both components are ready. The two components may then be combined in order to form the item. The printed components can be easily associated together and not “lost”, they can be easily traced and associated to the main digital image.

If the item is for example a portion of a human body, all components of the 3D print of the item are formed at the same time in the same “batch” and the traceability is improved. The machine processes together various components forming the item at the same time.

Further, the time to create the whole item is reduced compared to the time needed to process the components in series.

According to a second aspect, the invention relates to a method to form a three-dimensional object and a tool from a first and a second solidifiable materials being capable of solidifying upon impingement thereon of electromagnetic radiation, the method comprising:
providing a first digital image of a three dimensional object;
providing a second digital image of a tool to be used on the three dimensional object;
introducing said first and said second solidifiable material in a first and a second chamber, respectively;
associating to the first chamber the first digital image and to the second chamber the second digital image;
irradiating by means of an electromagnetic source a layer of said first and/or said second solidifiable material, according to a given pattern, in order to selectively solidify the layer of the first and/or the second solidifiable material;
repeating the process for a plurality of layers to form the three dimensional object and the tool;
while repeating the process, forming the three-dimensional object and the item in parallel, by irradiating both chambers at the same time, or by alternating the irradiation from the first to the second chamber and vice versa.

In this second aspect, the method of the invention uses the same stereolithographic machine as described according to the first aspect. The difference in this case relates to the type of traceability achieved. In the first aspect, from a single item formed in different components, there is an association between the main digital image of the item itself and all the three-dimensional components produced by the stereolithographic machine. In the case according to the second aspect, there is an association between an item (three dimensional object) and a tool which is used to work on the item. The tool has a shape that might depend on the shape of the item itself. Also in this case there is a need to trace the process flow and keep the association of “item+tool” with the objects which are printed. In this case therefore the digital images formed are the digital images of the tool and of the item. These digital images are then associated with the first and second chamber.

Of course a “mixed” solution can be envisaged as well, that is, the stereolithographic machine includes N>2 chambers and in one chamber the tool is formed, while in the N−1 remaining chambers the 3D components of the item are formed. Alternatively, the tool is also formed by different components in different materials and thus the tool itself is associated to several 3D components, each components being printed in a different chamber.

Regardless of the number of components and of the number of chambers, each component in each chamber is formed in parallel with the others. Preferably, a DLP source irradiates all chambers at the same time, so that layers of different components are solidified simultaneously. Preferably, a laser source alternates the irradiation from one chamber to the other recursively while forming multiple components in parallel.

The invention according to the first or the second aspect may include alternatively or in addition any of the following characteristics.

Preferably, according to the first aspect, the method includes the steps of:
associating an identifier to the main digital image of the three dimensional object; and
associating the same identifier to each of the formed first and the second components.

Preferably, according to the second aspect, the method includes the steps of:
associating an identifier to the first digital image of the three dimensional object;
associating the same identifier to the second digital image;
associating the same identifier to each of the formed three dimensional object and tool.

Preferably, associating an identifier or associating the same identifier comprises: forming the identifier or the same identifier on the first and the second components, or on the 3D object and tool, for example during the stereolithographic process. In this way, the traceability of the objects is even further enhanced. The identifier may be for example an alphanumeric string. The string may be associated to a patient. Alternatively, the identifier may be a symbol or logo in order to identify the production performed for a certain company.

Preferably, the method according to the first aspect includes the steps of:
providing a first and a second platform associated to said first and second chamber, respectively, where said first and second three dimensional components are formed layer by layer;
moving said first or second platform near a bottom of said first or second chamber, respectively, in such a way as to arrange it in contact with a layer of said first or said second solidifiable material;
moving said layer after irradiation away from said bottom to form a gap;
filling the gap between a new layer of said first or said second solidifiable material.

Preferably, the method according to the second aspect includes the steps of:
providing a first and a second platform associated to said first and second chamber, respectively, where said three dimensional object and tool are formed layer by layer;
moving said first or second platform near a bottom of said first or second chamber, respectively, in such a way as to arrange it in contact with a layer of said first or said second solidifiable material;
moving said layer after irradiation away from said bottom to form a gap;
filling the gap between a new layer of said first or said second solidifiable material.

In the stereolithographic machine used in the method of the invention, preferably the electromagnetic source is positioned below the first and second chamber and the movement of the first and second platform are along a Z axis upwards, that is, after the polymerization of a first layer, the next layer is formed below the first layer, and the platform is raised of a value substantially equal to a thickness of the layer.

In addition, for each layer, the method of the invention may include one or more of the following step:
a Z compensation. This compensation avoids the problems due to the depth of polymerization and the ensuing geometrical distortion. This compensation is described in International patent application WO 2016/001787 in the name of the same Applicant;
in case the electromagnetic source includes more than one laser, the combined activity of the two laser sources is controlled according to the method described in WO2016/016754 in the name of the same Applicant;
the movement of the platform approaching the chamber may be segmented according to the method described in WO 2014/013312 in the name of the same Applicant;
analogously, the movement of the platform away from the chamber may be controlled according to WO 2012/098451 in the name of the same Applicant.

Preferably, providing a main digital image or a first digital image of a three dimensional object includes the step of:
scanning the three dimensional object.

The three dimensional object (item) therefore can be a “physical entity” and in order to obtain a digital image of the same, a scan is performed. For example, the scanner can be an oral scanner capable of performing a scan of a portion of the gum and teeth. The digital image obtained by the scan can be in any format, and it can be further elaborated as needed.

Preferably, the method includes the steps of:
setting first working parameters of the electromagnetic source applicable when the electromagnetic radiation impinges on the first solidifiable material;
setting second working parameters of the electromagnetic source applicable when the electromagnetic radiation impinges on the second solidifiable material; wherein at least one of the first working parameters is different to one of the second working parameters.

The working parameters, either first or second, may include one or more of the following:
the power of the electromagnetic radiation emitted;
in case of a laser source, the spot compensation;
in case of a digital light projector, the exposure time.

The above parameters may differ between the two chambers and in addition may differ layer by layer. The parameters can be modified also during the process itself.

Preferably, the method includes the steps of:
setting first working parameters of file elaboration applicable to the first digital image;
setting second working parameters of the file elaboration applicable to the second digital image; wherein at least one of the first working parameters is different to one of the second working parameters.

The working parameters of file elaboration relate to one or more of:
the slicing process, thus the thickness of the layers;
hatching;
spot compensation;
Z compensation (WO 2016/001787 mentioned above);
the contouring of the various pattern formed.

Preferably, the electromagnetic source is a laser or a digital light projector.

Preferably, the first and/or the second solidifiable liquid material is a photopolymer resin.

Preferably, the step of moving the solidified layer of the first and/or the second solidifiable material includes:
providing a first and a second platform facing said first and second chamber, respectively;
shifting the position of the first and second platform with respect to the first and second chamber, respectively.

More preferably, the shifting of the first platform is different from the shifting of the second platform in value.

The platforms support the first and the second components or the 3D object and tool. The platforms are shifted, or translated, along a Z direction that it is preferably perpendicular to a bottom of the chambers. The shifting depends on the layers' thickness. Due to the fact that the number/thickness of the layers in which the first component/object is divided and the number/thickness of the layers in which the second component/tool is divided can be different, to certain Z coordinates at which the platforms are moved there can be the irradiation of the first and second chamber, while for other Z coordinates only one chamber is irradiated. The chamber which is irradiated the most corresponds to the chamber in which the components sliced in the biggest number of layers is present.

Preferably, the object or the first or second component is a portion of a human body.

Preferably, the tool is a surgical tool.

Preferably, said tool is form-fitting a portion of an external surface of the three dimensional object.

The method of the invention is particularly useful in the medical or dental sector, where the requirements of traceability are particularly stringent. Therefore, for example in the dental field, the item can be a part of the oral cavity. The part of the oral cavity might be scanned (intraoral scanner), or an impression can be made of the oral cavity and a scan is then performed of the impression itself.

Preferably, the step in which the main digital image is divided in a first digital image corresponding to the first component and in a second digital image corresponding to the second component comprises:
separating in the main digital image volumes having different colours or different names to form a plurality of components, one for each colour or name respectively;
selecting among the plurality of components the first and second component.

There are several possible methods to divide the main digital image of the item in the various components. These methods may be manual (i.e. an operator is required) or automatic. Generally a characteristic which is different in the two components is used to differentiate the two, for example the colour.

The location in the first and/or second chamber where the first and/or second 3D object is printed can be selected “manually” via a user interface.

Preferably, the method comprises the step of:
modifying the main or the first or the second digital image.

The digital images may be modified to alter for example their shape. This is in particular useful when the main digital image or the first/second image of the 3D object/tool is obtained by scanning a physical item. The digital image can be altered or completed: for example if a digital image of a dental arch is obtained, where a tooth is missing, the tooth can be “replaced” via 3D modelling.

The invention will be better described below with a non-limiting reference to the appended drawings, where:

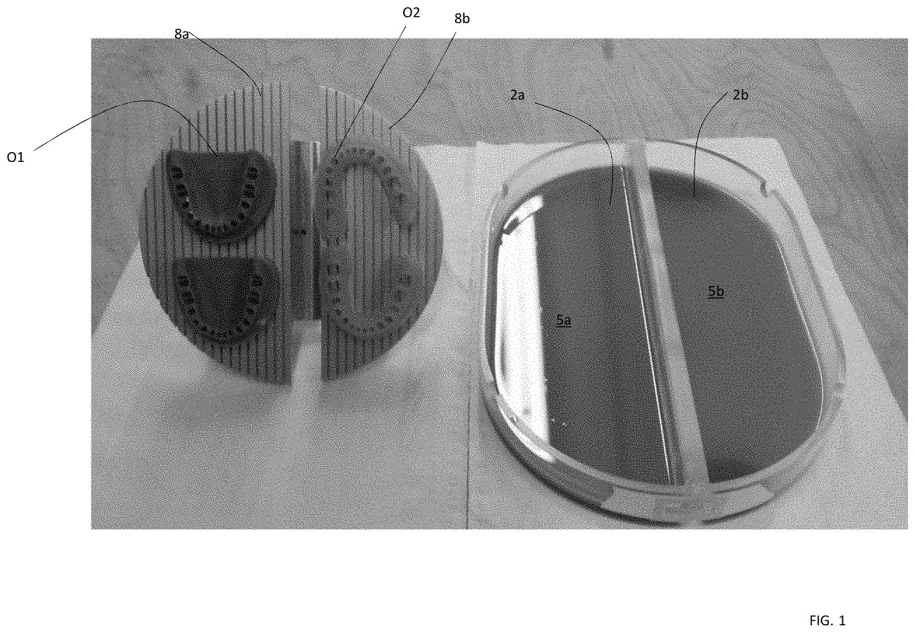

FIG. 1 is a photograph of a first and a second chamber of the invention where a first and a second 3D objects have been printed and of the first and second 3D objects;

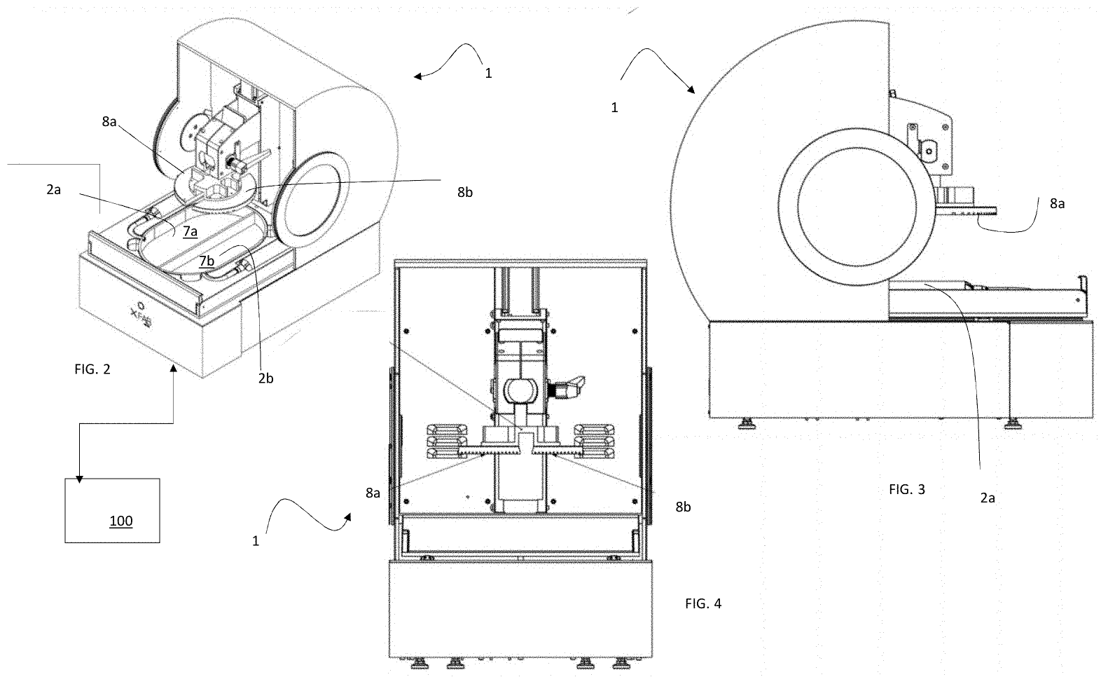

FIG. 2 is a perspective view of the stereolithographic machine used in the method of the invention;

FIG. 3 is a lateral view of the machine of FIG. 2;

FIG. 4 is a front view of the machine of FIGS. 2 and 3;

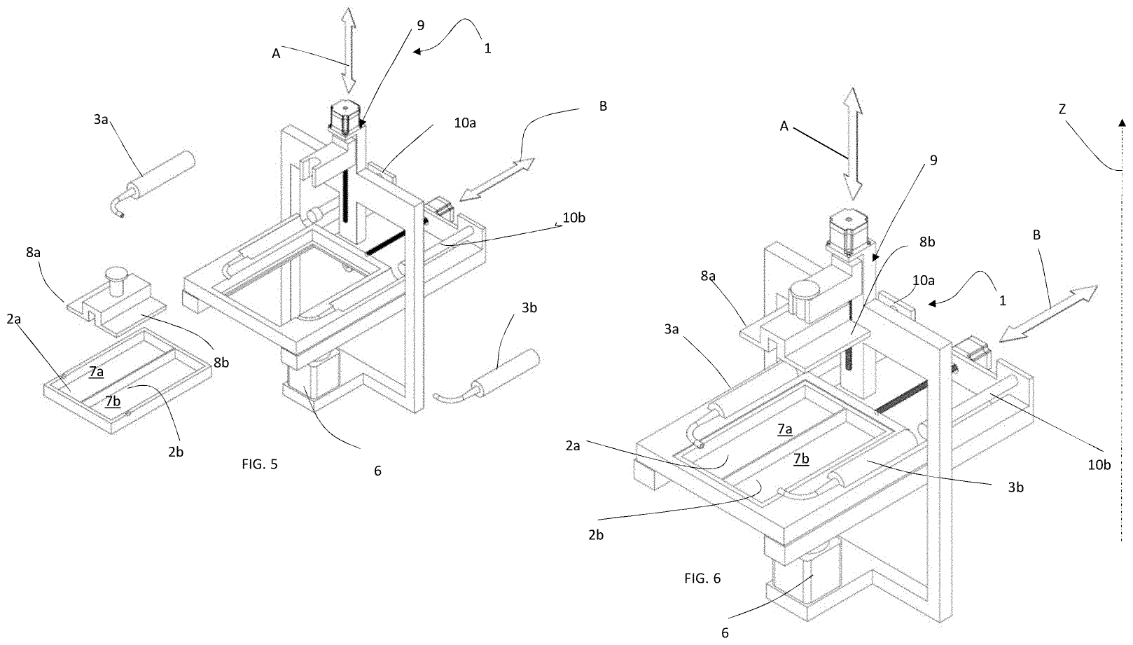

FIG. 5 is an isometric view of a portion of the machine of FIGS. 2-4;

FIG. 6 is an exploded view of FIG. 5;

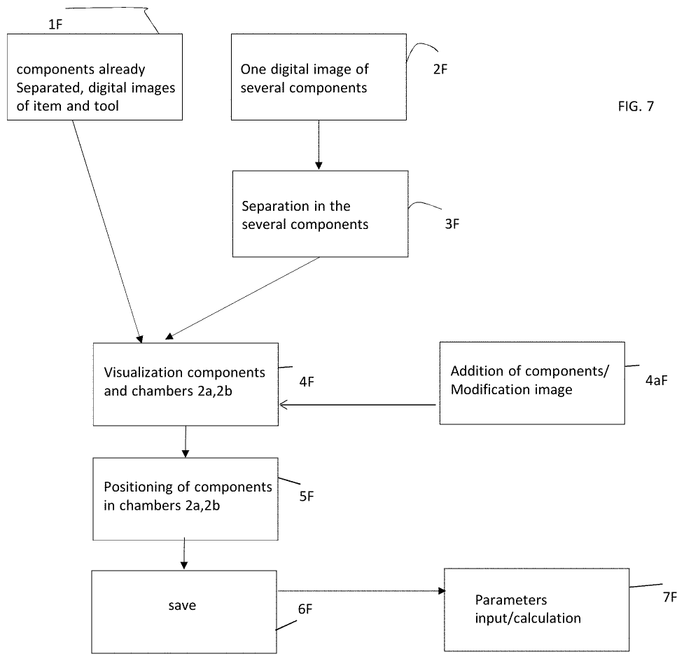

FIG. 7 is a flow chart of some steps of the method of the invention; and

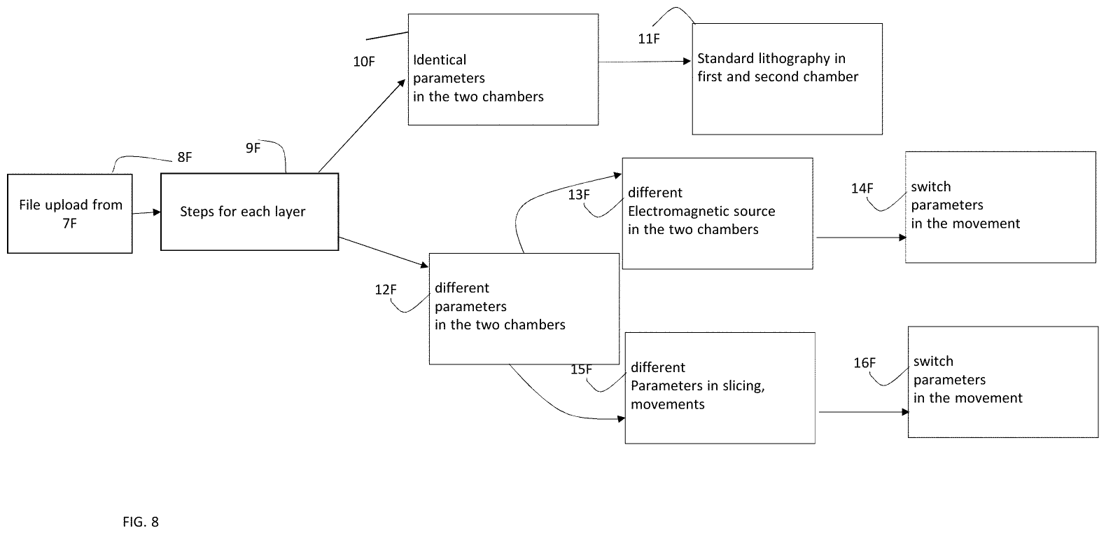

FIG. 8 is a flow chart of further steps of the method of the invention.

The method of the invention is described with reference to a stereolithography machine indicated as a whole by 1 in FIGS. 2-4. The machine 1 is apt to perform the method of the invention, i.e. it is apt to “print” a three-dimensional (3D) object (item) formed by at least two components O1 and O2 using a first and a second chamber 2a, 2b, as depicted in FIG. 1. The first and second components are for example a gum portion and a dental arch (see FIG. 1). Alternatively or in addition, the machine 1 is apt to “print” a three-dimensional (3D) object related to an item and a three dimensional object of a tool to be used on the item.

The stereolithographic machine 1 includes a first and a second cartridge 3a, 3b containing a first and a second solidifiable substance or material 5a, 5b suited to be solidified through exposure to predefined electromagnetic radiation. The first and second cartridge 3a, 3b are in fluid communication with the first and second chambers 2a, 2b so that the first and second substance can flow inside the first and second chamber 2a, 2b, respectively. The machine 1 includes also a first and a second piston 10a, 10b (see the exploded views of FIGS. 5, 6): the first and second substance can be introduced from the cartridges to the chambers by means of a pressure exerted by the pistons 10a, 10b when introduced in the cartridges. The first and second solidifiable substance 5a, 5b can be visible in FIG. 1 where they are of different colours. The first or second solidifiable substance is in liquid form, it might be more or less dense and, when introduced inside the first or second chamber, its upper surface assumes a substantially flat shape.

The first or second solidifiable substance 5a, 5b preferably is a light-sensitive polymeric liquid resin and the predefined radiation is light radiation.

The machine 1 also comprises an electromagnetic source 6 apt to emit the electromagnetic radiation. The source 6 is capable of selectively irradiating a layer of the first or second solidifiable substance 5a, 5b having a predefined thickness and arranged adjacent to a bottom 7a, 7b of the first or second chamber 2a, 2b so as to solidify it.

The source 6 is preferably arranged under the first and second chamber 2a, 2b (this configuration is better visible in FIGS. 5 and 6) and is configured to direct the electromagnetic radiation towards the bottom 7a, 7b of the first and second chambers 2a, 2b, which are preferably transparent to the electromagnetic radiation emitted by source 6. Therefore, the first and second solidifiable material 5a, 5b is irradiated from below. The electromagnetic radiation is so selected that it solidifies the first and second substance 5a, 5b.

Preferably, if the first or second solidifiable material 5a, 5b is a light-sensitive resin, the source 6 comprises a laser light emitter associated with an optic (not depicted) suited to direct the light beam towards any point of the above mentioned layer of the first or second solidifiable material.

Alternatively, the source comprises a projector suited to generate a luminous image corresponding to a surface area of the layer of first or second solidifiable material to be solidified.

The stereolithography machine 1 further comprises a first and a second platform 8a, 8b, having the function of modelling plates, facing the bottom 7a, 7b of the first and second chamber 2a, 2b and suited to support the three-dimensional components O1, O2 being formed (see for example again FIG. 1).

The machine 1 further includes a first actuator 9 (better visible in FIGS. 5 and 6) connected to the first and second platforms 8a, 8b suited to move them with respect to the bottom 7a, 7b of chambers 2a, 2b according to a modelling direction A preferably perpendicular to the same bottom 7a, 7b. This direction A is indicated in FIGS. 5 and 6 with an arrow. Preferably, this direction is parallel to the vertical (Z) axis. In particular, the first and second platforms 8a, 8b are realized (for example, the material chosen, the surface treatment, etc.) in such a way that a layer of the first or second solidifiable material adheres to them once it has solidified.

On the contrary, the bottom 7a, 7b of the chambers 2a, 2b is preferably made of a material that prevents said adhesion.

The chambers 2a, 2b may move along an axis B, preferably perpendicular to A. A movement of the chambers in this direction allow the introduction of the materials 5a, 5b in the chambers 2a, 2b because it corresponds to a translation of the pistons 10a, 10b in the cartridges 3a, 3b.

Further, the stereolithographic machine 1 includes or is connected to a processor 100 (indicated schematically in FIG. 2) commanding machine 1 and including a user interface where parameters may be inputted or modified.

The initial steps of the method of the invention making use of the stereolithographic machine 1 are schematically depicted in FIG. 7.

A digital image of a three dimensional object representing an item is provided, or a digital image of an item and a digital image of a tool are provided. The digital image may be obtained by scanning an item or drawn for example via a CAD program as a model. The item or the tool may include a plurality of components, each of which is formed of a different material. For example, the item is a portion of an oral cavity and the components are a portion of gum and a portion of dental arch.

If each image (image of the item and possibly image of the tool) is related to a single component to be printed, the files are uploaded in a suitable software (Phase 1F). Otherwise, if the digital image received relates to an item including more than one component (see phase 2F) without separation, the image needs to be divided in components, one component for each element (see phase 3F).

The various components (i.e. their geometry and size) and the chambers 2a, 2b are preferably visualized, for example in the user interface (phase 4F). The operator then preferably positions the various components in the first or in the second chamber 2a, 2b taking into consideration their size and the available solidifiable materials 5a, 5b (phase 5F). The selection and positioning performed is then saved in the software (phase 6F).

The digital image of the first and second components may be then further elaborated (phase 4aF), for example, the three dimensional shape of the component may be altered or modified.

Given the elaborated files at the end of phase 6F, the parameters of the stereolithographic process are determined. These parameters may be inputted by means of the user interface or may be automatically determined by the processor 100.

The parameters are one or more of the following:
parameters relative to the layers. Slicing and shrinkage. The dimensions of the layers is variable and it is determined here.
Parameters relative to the path which is to be scanned by a laser source (in case the electromagnetic source is a laser source). These parameters include hatching, border, z compensation, etc.
Parameters relative to the movements of the machine 1 not related to the layer-by-layer movements, such as those described in patents WO 2014/013312 and WO 2012/098451.
Parameters of the electromagnetic source 6 (power, size of the laser beam, etc.).

Given the parameters, one set associated to each chamber 2a, 2b, for each cycle the following steps are performed in the method of the invention, as depicted in FIG. 8.

If all the parameters in the first and in the second chamber, that is, if the parameters of the electromagnetic source and the parameters of the slicing and movements in general are the same for the orienting of both objects (phase 10F) a substantially “standard” stereolithography is performed (phase 11F). The electromagnetic source irradiates the first or the second chamber (or both) according to the given pattern given by the elaborated file obtained in step 7F.

The layer of first and second solidifiable material 5a, 5b is then selectively irradiated in order to obtain a first and a second solidified layer, which adheres to the platforms 8a, 8b.

Successively, the platforms 8a, 8b are lifted by means of actuator 9 in such a way as to move the solidified layers away from the bottom 7a, 7b of the chambers 2a, 2b and the cycle is repeated for the next layer.

If the parameters in the first and in the second chamber are different (see phase 12F), two cases may arise. The first one is when only the parameters of the electromagnetic source are different (phase 13F). In this case, the parameters of the source should be changed when there is a movement passing from one chamber to the other (in case of a laser), phase 14F. In case of a projector, the exposure time are changed, that is, the time during which one chamber is irradiated is different from the time another chamber is irradiated.

If the different parameters are in the slicing or anyhow in movements that the platforms/chamber/machine 1 have to perform (phase 15F), then there is a complete different separation of the two elaborations, the control of the irradiation of each layer in the first chamber is “separated” from the control of the irradiation of each layer in the second chamber (phase 16F).

### EXAMPLE 1

The following is an example for the realization of the three dimensional object formed by components O1 and O2 of FIG. 1. The item is a portion of oral cavity, divided in component “dental arch” O1 and “gum” O2. In order to have a three dimensional shape of such item, a scan of the oral cavity is performed and a single digital image is obtained. The digital image is divided in the digital image for component corresponding to the dental arch and the digital image component corresponding to gum portion. Possibly, the images are elaborated, for example to complete a missing portion of the dental arch.

The components are printed with additional “blocks”: not only the shape of the components is printed, but they are connected to “elevation blocks” which are also printed and used as supports for the components. Therefore, in the following table 1, “block 1 and 2” are the supports, while “block 3” are components O1 and O2 (fabricated in resins RD095 and GL4000 which are the material 5a and 5b).

The fabrication of block 1 and block 2 takes approximately 15-20 minutes, while the fabrication of block 3 takes several hours.

The two components O1 and O2 are then connected in order to form a single item.

The printing is performed in parallel with the parameters identified below. In other words, the laser spot follows a path which jumps from component O1 to component O2 and vice versa multiple times during the forming process. Δt indicates the time to fabricate the objects.

The electromagnetic source 6 is a laser source.

TABLE 1

| | | Resin 1 | Shrinkage: | | Resin 2 | Shrinkage: | |
|---|---|---|---|---|---|---|---|
| | meaning | (RD095) | 0.300 | | (GL4000) | 0.300 | |
| Blocks (n) | (support -n.1/2- | 1 | 2 | 3 | 1 | 2 | 3 |
| | object 3) | | | | | | |
| To z (mm) | Height of the | 0.2 | 1 | 0 | 0.2 | 1 | 0 |
| | block | | | | | | |
| Layers (n) | Number of | 4 | 16 | 351 | 4 | 16 | 316 |
| | layers | | | | | | |
| Slice (mm) | Thickness of | 0.05 | 0.05 | 0.05 | 0.05 | 0.05 | 0.07 |
| | layers | | | | | | |
| Contours (n) | n. of times the | 2 | 2 | 2 | 3 | 3 | 3 |
| | laser goes | | | | | | |
| | around the | | | | | | |
| | contour of the | | | | | | |
| | area | | | | | | |
| Spot | Size (radius) of | 0.02 | 0.02 | 0.02 | 0.03 | 0.03 | 0.03 |
| compensation | the laser spot | | | | | | |
| (mm) | | | | | | | |
| Hatching (mm) | Distance | 0.07 | 0.07 | 0.06 | 0.07 | 0.07 | 0.06 |
| | between laser | | | | | | |
| | trajectories | | | | | | |
| Z | WO | 0.120 | 0.120 | 0.120 | 0.140 | 0.140 | 0.140 |
| compensation | 2016/001787 | | | | | | |
| (mm) | | | | | | | |
| Laser speed | | 258 | 2200 | 3800 | 258 | 2200 | 4300 |
| (mm/sec) | | | | | | | |
| Δt1 = 3 h 17′ | | | | | Δt2 = 2 h 37′ | | |

1. A method to form a three-dimensional object including a first and a second component (O1, O2) from a first and a second solidifiable materials (5a, 5b) being capable of solidifying upon impingement thereon of electromagnetic radiation, the method comprising:
providing a main digital image of the three dimensional object;
introducing said first and said second solidifiable material (5a, 5b) in a first and a second chamber (2a, 2b), respectively;
elaborating the main digital image dividing it in a first digital image corresponding to the first component and a second digital image corresponding to the second component;
associating the first component to the first chamber and the second component to the second chamber;
irradiating by means of an electromagnetic source (6) a layer of said first and/or said second solidifiable material (5a, 5b), according to a given pattern, in order to selectively solidify the layer of the first and/or the second solidifiable material;
repeating the process for a plurality of layers to form the first and the second components (O1, O2) of the three dimensional object;
while repeating the process, forming the first and the second components in parallel, by irradiating both chambers at the same time, or by alternating the irradiation from the first to the second chamber and vice versa.

2. (canceled)

3. The method according to claim 1, further comprising:
associating an identifier to the main digital image of the three dimensional object; and
associating the same identifier to each of the formed first and second components (O1, O2).

4. (canceled)

5. The method according to claim 1 further comprising:
providing a first and a second platform (8a, 8b) associated to said first and second chamber (2a, 2b), respectively, where said first and second three dimensional components or said three dimensional object and said tool are formed layer by layer;
moving said first or second platform (8a, 8b) near a bottom (7a, 7b) of said first or second chamber, respectively, in such a way as to arrange it in contact with a layer of said first or said second solidifiable material;
moving said layer after irradiation away from said bottom so as to make it emerge from said first or said second solidifiable material (5a, 5b);
redistributing said first or said second solidifiable material in said first or second chamber so as to fill the depression caused by said movement of said layer away from said bottom.

6. The method according to claim 1, wherein providing a main digital image or a first digital image of a three dimensional object includes the step of:
scanning the three dimensional object.

7. The method according to claim 1 further comprising:
setting first working parameters of the electromagnetic source (6) applicable when the electromagnetic radiation irradiates the first solidifiable material (5a);
setting second working parameters of the electromagnetic source (6) applicable when the electromagnetic radiation irradiates the second solidifiable material (5b); wherein at least one of the first working parameters is different to one of the second working parameters.

8. The method according to claim 1, further comprising:
setting first working parameters of file elaboration applicable to the first digital image;
setting second working parameters of the file elaboration applicable to the second digital image; wherein at least one of the first working parameters is different to one of the second working parameters.

9. The method according to wherein the electromagnetic source (6) is a laser or a digital light projector.

10. The method according to claim 1, in which the first and/or the second solidifiable liquid material (5a, 5b) is a photopolymer resin.

11. The method according to claim 5, wherein the step of moving the solidified layer of the first and/or the second solidifiable material (5a, 5b) includes:
providing a first and a second platform (8a, 8b) facing said first and second chamber, respectively;
shifting the position of the first and second platform with respect to the first and second chamber (2a, 2b), respectively.

12. The method according to claim 11, wherein the shifting of the first platform is different in value from the shifting of the second platform.

13. The method according to claim 1, wherein the first or second component is a portion of a human body.

14.-16. (canceled)

17. The method according to claim 1, wherein the step of elaborating the main digital image dividing it in a first digital image corresponding to the first component and a second digital image corresponding to the second component comprises:
separating in the main digital image volumes having different colors or names to form a plurality of components, one for each color or name respectively;
selecting among the plurality of components the first and second component.

18. The method according to claim 1 further comprising:
modifying the main digital image or the first or the second digital image.
